(19) United States
(12) Patent Application Publication
(10) Pub. No.: US 2009/0127485 A1
(43) Pub. Date: May 21, 2009

(54) ANTI-SURGE ACTUATOR

(75) Inventors: Jorgen Wessel, Asker (NO); Vidar Sten-Halvorsen, Kongsberg (NO); Torstein Kasin, Kongsberg (NO); John A. Johansen, Kongsberg (NO)

Correspondence Address: Henry C Query Jr, 504 S Pierce Avenue, Wheaton, IL, 60187, US

(73) Assignee: FMC KONGSBERG SUBSEA AS, Kongsberg (NO)

(21) Appl. No.: 11/794,562

(22) PCT Filed: Dec. 27, 2005
(86) PCT No.: PCT/NO2005/000486

§ 371 Date: Sep. 8, 2008

(30) Foreign Application Priority Data
Dec. 30, 2004 (NO) 20045720

(51) Int. Cl. F16K 31/04

(52) U.S. Cl. 251/69; 251/129.13; 251/74

(57) ABSTRACT

The present invention describes a valve actuator having a first motor (30) for moving a valve element and a second motor (30′) for energizing a failsafe spring (130). The second motor is operated independently from the first, thus allowing the valve element to be moved between its open and closed positions while the spring is energized. In an emergency, the spring will be de-energized and move the valve element to its failsafe position no matter the position of the valve element.

### BACKGROUND OF THE INVENTION

The present invention relates to an actuator for a valve. More specifically, the invention relates to an electrically powered valve actuator having a spring return feature.

In many gas compression applications, a “surge” occurs when the compressor outlet pressure is too high relative to the flowrate. Because surge can cause severe damage to the compressor and other equipment, and can endanger human life, it may be necessary to provide an anti-surge valve to prevent surge by bleeding off pressure from the compressor outlet. When excessive outlet pressure exists or is about to occur, the anti-surge valve will open and bleed pressure-off the outlet. Depending on the working fluid and the environment, the anti-surge valve may be connected between the compressor inlet and outlet, or it may vent the compressor outlet to the atmosphere, or to a storage vessel.

To prevent equipment damage or danger, it is vitally important that the valve opens quickly. Typically the required opening time is just a few seconds. This time constraint creates a challenge when using electric valve actuators. While fluid powered linear actuators can typically actuate a valve in such time, electric actuators usually have much slower actuation times, due to the gearbox and rotary to linear converting mechanism, which sets up larger frictional and inertial forces in the transmission.

U.S. Pat. No. 6,572,076 discloses a valve actuator comprising an electric motor that moves a valve stem. A spring is compressed to act as a failsafe device in the event of loss of power. The motor is first driven backwards to compress the spring, and the spring is locked in position using an electromagnet. Thereafter the motor can be operated to open and close the valve in a controlled manner without compressing or releasing the spring. In an emergency, a loss of power will cause the electromagnet to be switched off, releasing the spring and thus forcing the valve closed.

### DETAILED DESCRIPTION OF THE PREFERRED EMBODIMENT(S)

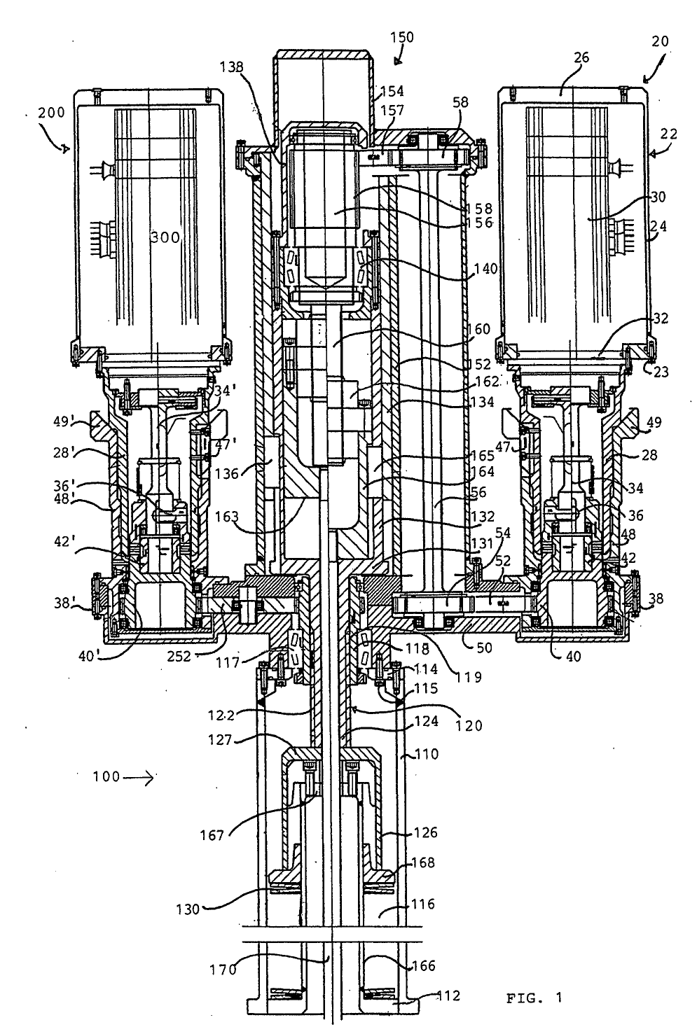

FIG. 1 shows a partial cross-sectional view of the actuator of the present invention during working mode,

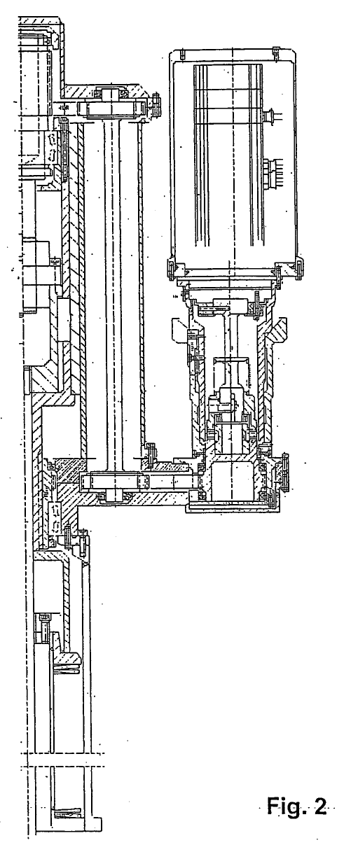

FIG. 2 shows a partial cross-section of the actuator in spring return mode,

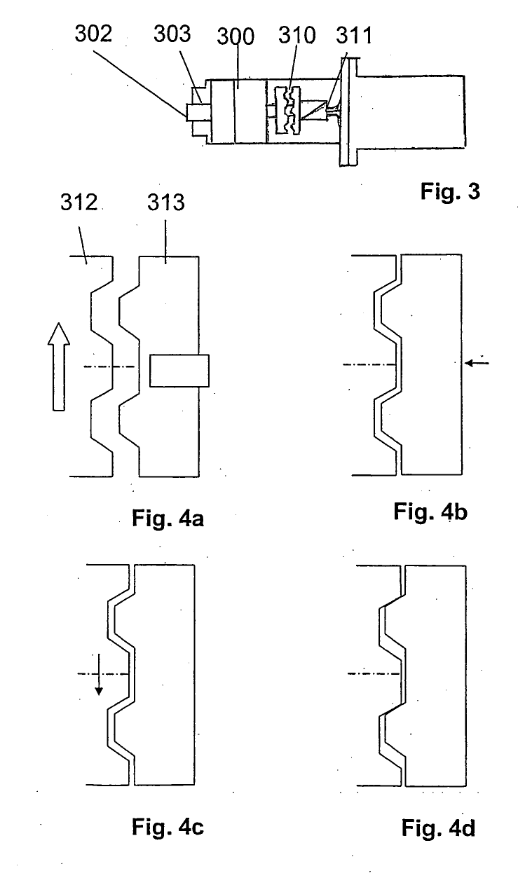

FIG. 3 is a drawing of the motor holding brake, and

FIG. 4 a-d shows the steps of operating the brake in FIG. 3.

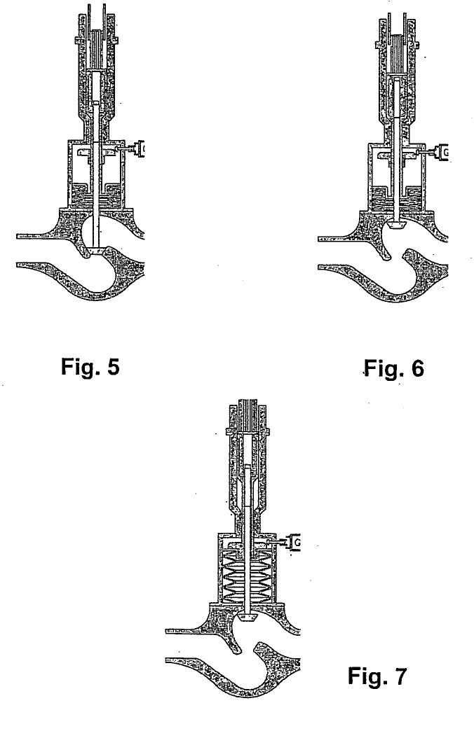

FIG. 5-7 shows the sequences for opening and closing the valve.

FIG. 1 is a composite drawing showing the actuator in its working mode with the left hand side and right hand side corresponding to the valve in the open and closed positions, respectively.

A spring return unit 100 is attached to a plate 50 and comprises an outer housing which includes an outer wall 110, upper plate 114, and lower plate 112. Upper plate 114 is fixed to plate 50 with screws 115 as shown. To the lower plate is rigidly attached a cylindrical sleeve 166 that extends upwards inside the housing. An annular spring holder 168 is axially movable along the outside of sleeve 166. Lower plate 112, sleeve 166, spring holder 168 and outer wall 110 thus define a spring chamber 116 containing the spring element 130. Spring element 130 may comprise any suitable resilient element, such as a coil spring or a Belleville stack.

The sleeve 166 comprises an upper lid 167. Upper lid 167 and lower plate 112 have holes through which a valve stem 150 is glidingly sealed (not shown) such that the valve stem can move axially in relation in the housing 100. Valve stem 150 to moves a valve element (not shown) into and out of engagement.

A spring actuating sleeve [Ref. #?] comprises lower part 126 that abuts spring holder 168, a middle part 126 and an upper part 132. The middle part 126 has a smaller outer diameter, terminating in shoulders 127 and 131, which limit the axial movement of the actuating sleeve. Middle sleeve 124 extends through a hole in the plate 50 and has threads 122 along at least a part of its length. At its upper end the upper part 132 has bearing elements 140 and a coupling sleeve 138 attached thereto. A rotating sleeve 118 is attached to plate 50 such that it can revolves in bearings 117 but is axially immovable. Rotating sleeve 118 has inner threads 120 which interact with the threads 122 on middle part 124 of the spring actuating sleeve. Furthermore, valve stem 150 is axially movable within spring actuating sleeve middle part 124. The upper part 132 has splines 136 which engage corresponding splines on rotation prevention sleeve 134. From this it is understood that the spring actuating sleeve is free to move axially but is prevented from rotation relative to plate 50.

A transmission unit 150 comprises a housing that at its lower end is rigidly attached to plate 50, and includes an outer wall 152 and an upper lid 154. The rotation prevention sleeve 134 is rigidly held within outer wall 210. A drive coupling 156 is rotatably mounted in coupling sleeve 138 in the bearings 140. Drive coupling 156 includes a drive member 158 such that the drive coupling can be rotated by a motor and gearbox assembly, as will be more fully described hereinafter. From this it can be understood that the drive coupling 156 is axially displaceable within housing 150 together with the spring actuating sleeve 126, 124, 132 while the coupling 156 can rotated relative to said sleeve.

A drive shaft 160 is connected to drive coupling 156 and is in turn attached to a roller screw nut 162. Roller screw nut 162 engages the upper end of valve stem 150 in a manner well known in the art, such that rotation of roller screw nut 162 is converted into axial movement of the valve stem 150 relative to the roller screw nut.

A roller screw nut sleeve 164 is attached to roller screw nut 162. Splines 165 engages spring actuating sleeve part 132, thus preventing rotation of sleeve 168 but ensuring that sleeve 168 and roller screw nut 164 are axially movable in relation to upper sleeve part 132. At its lower end, the sleeve 164 has a shoulder 163 that abuts shoulder 131, thus limiting downward movement of sleeve 164.

The mounting plate 50 contains various drive transmission components for transmitting rotation from the motors to the spring actuating sleeve and the drive coupling. On each side of the plate there are attached box units 38, 38′. The two box units are identical, and thus the following description will only refer to the right hand box unit, “′” but will apply to both box units.

A gear wheel 40 is mounted in the box unit 38. Gear wheel 40 engages a second gear wheel 52 which in turn engages a third gear wheel 54. A rotating shaft 56 is rigidly attached to the third gear wheel 54 and is at its upper end rigidly attached to a fourth gear wheel 58. Gear wheel 58 engages drive coupling splines 158 via transferring gear wheel 157.

Attached to the box unit 38 is an upwardly reaching cylindrical housing 48 that flares outwards at the top 49 for easier insertion of the drive motor unit 20. Guide pins 50 are located within housing 48 for orientation of the drive motor unit 20 as it is inserted into the cylindrical housing 48. The gear wheel 40 comprises an upwardly extending hollow shaft 42 that engages a motor drive shaft 34. Locking means 36 are used to lock the shaft 42 to the drive shaft 34 in a releasable manner.

Main drive motor unit 20 comprises the motor 30, gearbox 32 and drive shaft 34. The motor is sealingly enclosed in the unit 20, which has an outer wall 24 and an upper plate 26. The housing 22 is fixed to the gearbox unit 32 with screws 23. The drive unit 20 is preferably filled with a suitable hydraulic or silicon oil and pressure compensated to ambient pressure to protect the motor against seawater. A driveshaft protection and guiding sleeve 28 is fixed to the gearbox and protrudes downward, surrounding the driveshaft 34.

In the embodiment shown in the drawings, the main drive unit 20 is located alongside the main actuator housing 150. This is only a practical location for the purpose of saving height of the whole actuator. Alternatively the drive unit may for example be located at the extension of shaft 56 or even attached to the top of transmission housing 150.

The box unit 38′ includes gear wheel 40′ that is engaged with a second gear wheel 252 that in turn engages the teeth of spring rotation sleeve 118.

Spring actuating motor 300 is identical to the main drive motor 30, except that motor 300 also includes a holding brake which will is more fully described below with reference to FIGS. 3 and 4.

As long as current is fed to motor 300 the spring will be held in its compressed position. If power is removed from the motor, the spring force will move downwards with the lower part 126 abutting spring shoulder 168 and thus compressing spring 130. The downward movement is limited by the shoulder 131 abutting against the plate 50.

As long as current is fed to motor 300 the spring will be held in its compressed position. If power is removed from the motor, the spring will actuating sleeve 124 upwards and rotate the motor in the opposite direction. Since at that point there is no current in the motor it will run free and cause only little frictional resistance.

In FIG. 1 there is shown the situation where the spring 130 has been compressed to its normal operating position by operating motor 300. The roller screw nut is in its lower position. At the same time as the motor 300 is activated, the main motor 30 must also be operated to move the roller screw nut 162 to its upper position and valve stem 150, as shown on the right hand side of FIG. 2. The valve element is in its extreme upper position (FIG. 6). Now the motor 300 is run to energize the spring 130. This will also move spring actuating sleeve 126, 124, 132 and drive coupling sleeve 138 downwards. To have the roller screw nut 162 remain in this relative position as the rest moves downwards (and keep the valve stem in its upper position), the motor 30 is run backwards. This will result in the situation shown on the left hand side of FIG. 1. In this position, the main motor 30 may be engaged to rotate drive coupling 156 and the roller screw nut 162 to move the valve stem 150 downwards to close the valve. The valve can now be operated freely, i.e. to open and close the valve, without working against the spring 130. On the right hand side of FIG. 1 (see also FIG. 5) the valve stem is in its lower position, corresponding to a closed valve element.

In an emergency situation, upon loss of power, or if it becomes necessary to open the valve very quickly, the holding brake for motor 300 is de-energized. There are now two possibilities.
1. If the valve is in its closed position, the spring 130 will expand and force the spring actuating sleeve upwards. This in turn will move the whole unit consisting of spring actuating sleeve 126, 124, 132 and drive coupling sleeve 138 upwards until the valve elements abuts its upper shoulder. This will correspond to the drive coupling sleeve reaching its upper limit of travel, as shown on the right hand side of FIG. 2 (See also FIG. 7).
2. If the valve already is in its upper (open) position the spring will not immediately expand, being held back by the unmovable valve stem (the valve element abutting the “roof” or endstop of the valve). However, the force of the spring will put an upwards pressure on drive coupling sleeve and the sleeve 138 will therefore move slowly upwards, causing the roller screw nut to 162 rotate backwards (because the valve stem is not moving. The frictional forces in the roller screw nut, the drive system and the motor 30 will act like a damper. This returns the system automatically to its initial state, eliminating the need for a reset of motor 30 as long as the roller screw is not self locking due to increased friction etc.
3. If the valve is in any intermediate position, the spring will force the valve element upwards (since the whole unit moves as per 1 above) until the valve element abuts its upper position. Then the system will slowly reset as per 2 above.

The spring return mechanism is therefore not depended upon the valve position at the moment of activation. The system also functions to dampen out any shocks in the actuator, avoiding “slamming” of the valve element.

As shown in FIG. 2 the mechanism is not dependent uponshown with the valve fully open at the point of spring activation, while at right hand side of FIG. 2, the valve was closed. As can be inferred from FIG. 2, the mechanism will also work with the valve in any intermediate position.

The advantage with this arrangement is that the valve can be operated without having to energize the spring. This enables the valve to be operated quickly and often, with no more power than that which is necessary to drive the roller screw nut and not subject the fail safe spring to any fatigue due to high cycle numbers. The arrangement also enables the valve to be quickly opened in an emergency, even during an operating cycle.

In FIGS. 3 and 4 there is shown a preferred embodiment of a braking arrangement for the spring energizing motor. The motor 300 comprise a through-running drive shaft 302. The forward end of the drive shaft is operatively coupled to the gear box 303. The rear end of the drive shaft 302 extends behind the motor and terminates in a latch unit 310.

The latch unit 310 is shown in more detail in FIGS. 4A-4D, showing the sequence of actuation. The unit is in the form of a clutch with the left hand side 312 connected to the drive shaft 302 while the right hand side 313 is attached to a solenoid 311.

Before operating the motor 300, the clutch 310 is disengaged by interrupting the power to the solenoid 311. The right hand side 313 will move to the right, as shown in FIG. 4A. Motor 30′ can now be operated with the left hand side 312 rotating freely, as indicated by the arrow. This will compress the spring 130 as described earlier. When the spring has been fully compressed the solenoid is energized, causing the right hand side 313 to move into engagement with the left hand side 312, as shown in FIG. 4B. This will hold the motor shaft and prevent the spring from de-energizing. Upon loss of power the solenoid will de-energize and disengage the clutch 310 by moving the right hand part 313 to the right. The spring 130 will be released. The valve will therefore move to its failsafe position.

The method for performing the operation of the motor is as follows:

First the motor 30 is operated to rotate the drive shaft and hence the roller screw, to its upper position. Then motor 300 is operated to compress the spring. Electric power is still supplied to the motor 300 to hold the spring compressed. The brake solenoid 311 is now activated with a high current “kick”. The motor 300 is backed off slowly until latch teeth are engaged and then the motor torque can be reduced to zero, as in FIGS. 4c and 4d. When latch engagement and motor disengagement is verified, the holding current can be dramatically reduced. Alternatively, a low holding power requirement can be achieved by utilizing a second coil with high number of windings and a low holding current, to conserve continuous latching power

Controllability of torque, position and speed of the brushless DC motor is used to accurately sequence events:

Because the electric latch mechanism is interfacing, on the motor end of the drive train, the forces acting on the clutch are dramatically reduced first through the transmission and thereafter through the gear box. Holding forces and therefore continuous holding current will therefore be low. The electric latch mechanism will preferably be of an interference type where further mechanical advantage can be implemented using a tapered or conical device operated by a solenoid acting upon the rotating parts on the motor.

It should be recognized that, while the present invention has been described in relation to the preferred embodiments thereof, those skilled in the art may develop a wide variation of structural and operational details without departing from the principles of the invention. For example, the invention may be used with a failsafe close valve, that shuts off the flow through the valve.

1. In combination with a valve which includes a valve element that is connected to a valve stem and is movable between first and second positions, the improvement comprising a failsafe valve actuator which comprises:
a housing;
a spring for biasing the valve element towards its second position;
first actuating means for energizing the spring and for maintaining the spring in its energized condition;
second actuating means for moving the valve element, the second actuating means including a transmission which comprises a roller screw unit that is connected to the valve stem;
wherein the second actuating means is operable independently of the first actuating means; and
releasing means for releasing the spring from its energized condition to enable the spring to return the valve to its second position.

2. The combination of claim 1, wherein the first actuating means comprises an electric motor.

3. The combination of claim 1, wherein the second actuating means is comprises an electric motor.

4. A failsafe valve apparatus for use in a subsea environment, comprising:
a housing;
a valve stem which is movable between first and second positions to operate a valve element;
a spring for biasing the valve element toward its second position;
first actuating means for energizing the spring and for holding the spring in its energized condition;
second actuating means for moving the valve element independently of the spring, the second actuating means including a transmission which comprises a roller screw unit that is connected to the valve stem; and
a brake clutch arrangement for holding the first actuating means in position against the force of the spring;
wherein the spring is released upon loss of power to the brake clutch arrangement.

5. A valve as claimed in claim 4, wherein the first actuating means comprises an electric motor.

6. A valve as claimed in claim 4, wherein the brake clutch arrangement comprise a solenoid.

7. A valve as claimed in claim 4 wherein the second actuating means comprise an electric motor.

8. In combination with a valve which includes a valve stem that is movable between first and second positions, the improvement comprising a failsafe valve actuator which comprises:
a housing;
a spring actuating sleeve which is movable between first and second positions relative to the housing;
a spring which is operatively engaged between the spring actuating sleeve and the housing;
first actuating means for moving the spring actuating sleeve from its first position to its second position to thereby energize the spring;
second actuating means for moving the valve stem independently of the first actuating means, the second actuating means comprising a transmission component which is connected to the valve stem and is supported by the spring actuating sleeve;
wherein when the spring actuating sleeve is in its second position the second actuating means is operable to move the valve stem between its first and second positions;
wherein when the valve stem is in its first position and the spring is operable to move the spring actuating sleeve from its second position to its first position, the spring actuating sleeve will move the valve stem from its first position to its second position.

9. The combination of claim 8, wherein the first actuating means comprises a motor which includes a drive shaft.

10. The combination of claim 9, wherein the motor is coupled to the spring actuating sleeve through a rotary-to-linear motion converter.

11. The combination of claim 10, further comprising brake means for holding the spring actuating sleeve in its second position against the force of the spring.

12. The combination of claim 11, wherein the brake means comprises a latch unit which is connected between the drive shaft and a stationary member.

13. The combination of claim 12, wherein the latch unit is opened and closed by a solenoid.

14. The combination of claim 13, wherein when current is applied to the solenoid the latch unit will close and connect the drive shaft to the stationary member to thereby prevent the spring actuating sleeve from moving.

15. The combination of claim 13, wherein when current is removed from the solenoid the latch unit will open and disconnect the drive shaft from the stationary member to thereby allow the spring to move the spring actuating sleeve from its second position to its first position.

16. The combination of claim 8, wherein the transmission component comprises a drive shaft which is coupled to the valve stem through a roller screw nut.

17. The combination of claim 16, wherein the drive shaft is connected to a drive coupling which is rotatably supported in the spring actuating sleeve.

18. The combination of claim 17, wherein the drive coupling is driven by a motor and gear box assembly which is connected to the housing.
